(19) United States
(12) Patent Application Publication
(10) Pub. No.: US 2012/0120944 A1
(43) Pub. Date: May 17, 2012

(54) METHODS AND APPARATUSES FOR MULTI-RADIO COEXISTENCE

(76) Inventors: Xue Yang, Arcadia, CA (US); Shlomo Avital, Jerusalem (IL); Xingang Guo, Portland, OR (US)

(21) Appl. No.: 12/946,606

(22) Filed: Nov. 15, 2010

(51) Int. Cl. H04J 3/06

(52) U.S. Cl. 370/350

(57) ABSTRACT

A method for coexistence radio communication systems is presented. In one embodiment, the method includes receiving a realtime frame synchronization signal and receiving one or more frame parameters. The method further includes determining, based at least on the frame synchronization signal and the frame parameters, estimated frame timing information and scheduling transmission based on the estimated frame timing information to avoid collision of the transmission and reception.

### FIELD OF THE INVENTION

Embodiments of the invention relate to wireless communication; more particularly, embodiments of the invention pertain to coexistence between two or more radio communications.

### BACKGROUND OF THE INVENTION

Multi-radio platforms (MRP) are wireless communication devices with co-located transceivers that communicate using two or more communication techniques. In some cases, the two radio access technologies (RATs) are used to perform different functions. In such case, both radios need to maintain active connections to their respective networks at the same time.

One issue with multi-radio platforms is that interference between receptions and transmissions of the co-located transceivers may result in packet loss from collisions degrading the communication abilities of the radios. This is especially a concern in multi-radio platforms that include Wi-Fi (e.g., IEEE 802.11n-2009—Amendment 5: Enhancements for Higher Throughput. IEEE-SA. 29 Oct. 2009) and 4G-TDD broadband wireless radio transceiver because their frequency spectrums can be adjacent. Out-of-band (OOB) emissions from one transceiver may interfere with the other transceiver.

Examples of 4G-TDD broadband wireless radios are LTE (e.g., 3GPP release 10) or WiMAX (e.g., IEEE std. 802.16e-2005).

A WiFi transceiver and a 4G TDD (time-division duplex) radio transceiver may be deployed close to ISM band (e.g., 2.3˜2.4 GHz or 2.5˜2.7 GHz band). When one radio is transmitting, the radio may cause substantial interference to another co-located radio and prevent the co-located radio from receiving correctly.

### BRIEF DESCRIPTION OF THE DRAWINGS

Embodiments of the present invention will be understood more fully from the detailed description given below and from the accompanying drawings of various embodiments of the invention, which, however, should not be taken to limit the invention to the specific embodiments, but are for explanation and understanding only.

FIG. 1 is a block diagram of WiFi/4G coexistence system architecture in accordance with one embodiment of the invention.

FIG. 2A shows a waveform diagram for a downlink frame synchronization signal in accordance with one embodiment of the invention.

FIG. 2B shows a waveform diagram for an uplink frame synchronization signal in accordance with one embodiment of the invention.

FIG. 3A shows a waveform diagram for WiFi operations in a coexistence mode in accordance with one embodiment of the invention.

FIG. 3B shows a waveform diagram for WiFi operations during an uplink-downlink transition in accordance with one embodiment of the invention.

FIG. 4 is a flow diagram of one embodiment of a process if a transmission opportunity period is fixed.

FIG. 5 is a flow diagram of one embodiment of a process if a transmission opportunity period is variable.

FIG. 6 shows a waveform diagram for bidirectional WiFi operations in accordance with one embodiment of the invention.

FIG. 7 is a block diagram of WiFi/4G system architecture with a downlink active signal, in accordance with one embodiment of the invention.

FIG. 8 is a diagram representation of a wireless communication system in accordance with one embodiment of the invention.

### DETAILED DESCRIPTION OF THE INVENTION

A method for coexistence radio communication systems is presented. In one embodiment, the method includes receiving a realtime frame synchronization signal and receiving one or more frame parameters. The method further includes determining, based at least on the frame synchronization signal and the frame parameters, estimated frame timing information and scheduling transmission/reception based on the estimated frame timing information to avoid collision of the transmission and reception.

In the following description, numerous details are set forth to provide a more thorough explanation of embodiments of the present invention. It will be apparent, however, to one skilled in the art, that embodiments of the present invention may be practiced without these specific details. In other instances, well-known structures and devices are shown in block diagram form, rather than in detail, in order to avoid obscuring embodiments of the present invention.

Some portions of the detailed descriptions which follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments of present invention also relate to apparatuses for performing the operations herein. Some apparatuses may be specially constructed for the required purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, DVD-ROMs, and magnetic-optical disks, read-only memories (ROMs), random access memories (RAMs), EPROMs, EEPROMs, NVRAMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, embodiments of the present invention are not described with reference to any particular programming language. It will be appreciated that a variety of programming languages may be used to implement the teachings of the invention as described herein.

The methods and apparatuses described herein are for coexistence radio communication networks. Specifically, 4G/WiFi coexistence radio communication networks are primarily discussed in reference to a computer system. However, the methods and apparatuses are not so limited, as they may be implemented on or in association with any integrated circuit device or system, such as cell phones, personal digital assistants, embedded controllers, mobile platforms, desktop platforms, and server platforms, as well as in conjunction with other resources.

### Overview

A method for coexistence radio communication systems is presented. In one embodiment, the method includes receiving a realtime frame synchronization signal and receiving one or more frame parameters. The method further includes determining, based at least on the frame synchronization signal and the frame parameters, estimated frame timing information and scheduling transmission/reception based on the estimated frame timing information to avoid collision of the transmission and reception.

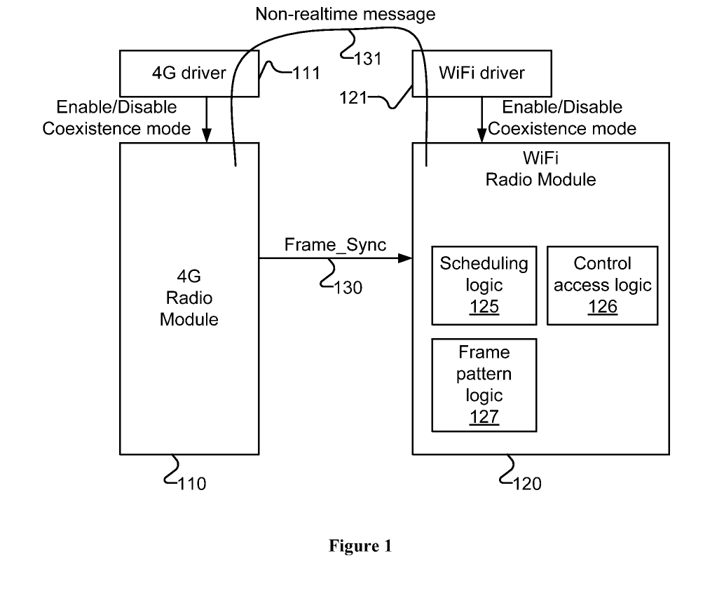

FIG. 1 is a block diagram of WiFi/4G coexistence system architecture in accordance with one embodiment of the invention. Many related components such as buses and peripherals have not been shown to avoid obscuring the invention. Referring to FIG. 1, the system comprises 4G radio module 110, 4G driver 111, WiFi radio module 120, and WiFi driver 121. In one embodiment, WiFi radio module 120 further comprises scheduling logic 125, control access logic 126, and frame pattern logic 127. In one embodiment, 4G radio module 110 sends frame synchronization signal 130 to WiFi radio module 120. 4G radio module 110 sends non-realtime messages 131 which contain frame parameters to WiFi radio module 120.

In one embodiment, the aforementioned units are shown as discrete components. Other embodiments are possible where some or all of units of a same RAT are integrated within a device or within other components. In other embodiments, the aforementioned units are distributed throughout a system in hardware, software, or some combination thereof.

In one embodiment, for example, simultaneous transmissions and receptions from co-located radios (e.g., 4G radio module 110 and WiFi radio module 120) results in failed receptions at a victim radio unless specified constraints are implied.

In one embodiment, a 4G TDD system (e.g., 4G radio module 110 and 4G driver 110) follows rigid frame structures with fixed frame duration. A typical frame period (duration) is 5 ms or 10 ms, such as, for example, the duration of a WiMAX frame is 5 ms, whereas, the duration of a LTE frame is either 5 ms or 10 ms. Within each TDD frame, there are downlink (DL) portion for receiving and uplink (UL) portion for transmitting. In one embodiment, WiFi radio module 120 is made aware of 4G frame pattern or frame timing information. WiFi radio module 120 aligns the operations based on the 4G frame pattern.

In one embodiment, 4G radio module 110 sends information about the 4G frame pattern to WiFi radio module 120. The 4G frame pattern is conveyed in conjunction with real time signaling, such as, for example, frame synchronization signal 130 (FRAME SYNC) or non-real-time messages. The non-realtime messages are communicated between driver modules of two radios (e.g., 4G driver 111 and WiFi driver 121). In one embodiment, the non-realtime messages include parameters about a frame structure, such as, for example, the duration of a frame, a downlink-uplink ratio, a time offset, etc. In one embodiment, WiFi radio module 120 uses a realtime signal, information from non-realtime messages, or both to determine frame timing information (frame pattern).

In one embodiment, 4G driver 111 and WiFi driver 121 are operable to determine whether to operate in the coexistence mode. In one embodiment, the coexistence mode is determined in conjunction with a wireless profile, an operating system, a user configuration setting, or combinations thereof. In one embodiment, WiFi radio module 120, co-located with 4G radio module 110, derives 4G frame pattern and then subsequently adjusts channel access procedure to align WiFi operations along with 4G UL/DL pattern. In one embodiment, the scheme does not require changes to the core network.

In one embodiment, a WiFi/4G coexistence system, in conjunction with little coordination between the co-located radios, enables WiFi radio module 120 to achieve about 20% to 40% of full throughput without affecting the operations of a 4G radio network (LTE or WiMAX). In addition, the system is applicable to WiFi and 4G subsystem that are discrete components or within an integrated package.

In one embodiment, a WiFi/4G coexistence system with respect to FIG. 1 do not rely on MAC coordination which requires an authority authoritative entity (e.g., MAC coordinator) to arbitrate the operational requests from each co-located radio and to resolve the conflict in realtime. Such an approach requires substantial coordination between co-located radios to exchange time information of scheduled operations from both radios. In one embodiment, a WiFi/4G coexistence system with respect to FIG. 1 do not rely on the filtering approach requires, for example, an additional 30 to 35 dB of filter attenuation to allow TX/RX simultaneous operations.

It will be appreciated by those skilled in the art that other RAT systems may be used while maintaining approximately the same characteristic.

In one embodiment, a mobile station, a UE, a receiver (in the downlink scenario) communicates with a base station. A base station is a transmitter in a downstream or downlink case. A transmitter may be interchangeably referred to as an advance base station, a base station (BS), an enhanced Node B (eNB), or an access point (AP) at the system level herein. In this downlink case, a mobile station is a receiver. A receiver may be interchangeably referred to as an advanced mobile station (AMS), a mobile station (MS), a subscriber station (SS), a user equipment (UE), or a station (STA) at the system level herein. Further, the terms ABS, BS, eNB, and AP may be conceptually interchanged, depending on which wireless protocol is being used, so a reference to BS herein may also be seen as a reference to either of ABS, eNB, or AP. Similarly, a reference to MS herein may also be seen as a reference to either of AMS, SS, UE, or STA.

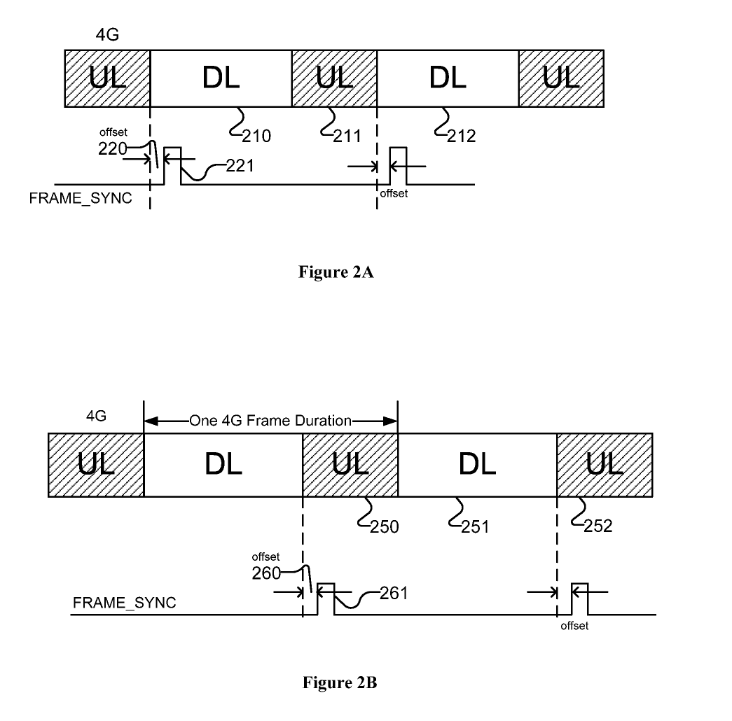

FIG. 2A shows a waveform diagram for a downlink frame synchronization signal in accordance with one embodiment of the invention. In one embodiment, referring to FIG. 2A, a 4G frame comprises a downlink portion (e.g., downlink period 210) and an uplink portion (e.g., uplink period 211). A frame synchronization signal shows synchronization pulse 221. The frame synchronization signal also shows an offset (i.e., offset 220) which is between a downlink period (DL) start time and the rising edge of frame synchronization pulse 221.

In one embodiment, a 4G TDD system follows rigid frame structures with fixed frame duration. The duration of a frame (frame period) is, for example, 5 ms or 10 ms (e.g., a WiMAX frame period is 5 ms, whereas, a LTE frame period is either 5 ms or 10 ms).

In one embodiment, as described herein, a TDD frame includes downlink portion for receiving data and uplink portion for transmitting data. In one embodiment, a WiFi radio is able to determine 4G frame timing information based at least on real time signaling, such as, frame synchronization signal 130 with respect to FIG. 1. In one embodiment, a frame synchronization signal (FRAME_SYNC) is indicative of (or defines) the beginning of a 4G downlink period (i.e., time which 4G transitions from uplink transmission to downlink reception) with an offset. In one embodiment, the offset is predefined. The offset (value) is communicated through one or more non-realtime messages.

In one embodiment, there is a short guard period when transitioning from a downlink period to an uplink period referred to herein as a downlink-uplink transition gap, a transmission transition gap (TTG), or a guard period (e.g., with respect to LTE). In one embodiment, there is a short guard period when transitioning from an uplink period to a downlink period referred to herein as an uplink-downlink transition gap, a reception transition gap (RTG), or a guard period (e.g., with respect to LTE). The length of a transitioning gap period (either a TTG or a RTG) is typically larger than 20 us. Transitioning gaps or guard periods will be described in further detail below with additional references to the remaining figures.

In one embodiment, by using a frame synchronization signal and frame parameters, such as, for example, offset 220, the duration of a 4G frame period (T_{frame}), and a downlink-uplink ratio (DL:UL ratio), WiFi radio module is able to derive the beginning of a downlink period, the beginning of an uplink period of a 4G frame, or both. In one embodiment, a downlink-uplink ratio is a fixed parameter determined by the 4G network.

In one embodiment, the beginning or the start time of a downlink period is referred to herein as a downlink period start time, or a DL start time (T_{DL}). In one embodiment, the beginning or the start time of an uplink period is referred to herein as an uplink period start time, or a UL start time (T_{UL}). In one embodiment, both T_{SL} and T_{UL} are derivable by a co-located WiFi radio module.

FIG. 2B shows a waveform diagram for an uplink frame synchronization signal in accordance with one embodiment of the invention. In one embodiment, referring to FIG. 2B, a 4G frame comprises a downlink portion (e.g., downlink period 251) and an uplink portion (e.g., uplink period 250). A frame synchronization signal shows synchronization pulse 261. The frame synchronization signal also shows an offset (e.g., offset 260) between an uplink period (UL) start time and the rising edge of frame synchronization pulse 261.

In one embodiment, a frame synchronization signal (FRAME SYNC) defines/is indicative of the beginning of 4G uplink portion (i.e., the time transitioning from downlink reception to uplink transmission) with a predefined offset.

### WiFi Operations and Coexistence Mode

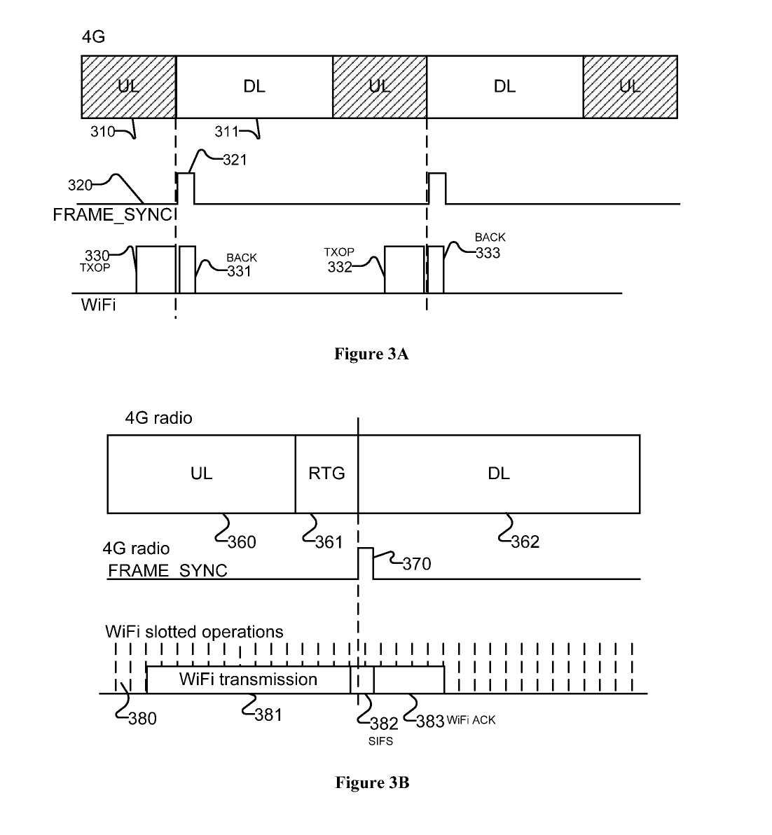

FIG. 3A shows a waveform diagram for WiFi operations in a coexistence mode in accordance with one embodiment of the invention. In one embodiment, referring to FIG. 3A, a 4G frame comprises a downlink portion (e.g., downlink period 311) and an uplink portion (e.g., uplink period 310). Frame synchronization signal 320 shows synchronization pulse 321. WiFi operations show transmission opportunity period (TXOP 330), TXOP 332, block acknowledgment (BACK 331), and BACK 332. BACK 331 is an acknowledgement with respect to TXOP 330. BACK 333 is an acknowledgment with respect to TXOP 332.

In one embodiment, for example, an offset of a frame synchronization pulse is not shown in FIG. 3A because it is a small value or is assumed to be zero.

In one embodiment, WiFi operations are performed in accordance with a basic co-existence mode. Simultaneous transmission and reception of co-located radios are prevented. For example, when a radio is receiving data, another radio is prevented from transmitting data. For another example, a WiFi radio module performs transmission during a 4G UL period (e.g., UL 310) but not during a 4G DL period (e.g., DL 311). A WiFi radio module receives data (e.g., an acknowledgment from an access point) during a 4G DL period (e.g., DL 311). In one embodiment, a WiFi radio module schedules transmission within TXOP 330 such that the transmission does not overlap with downlink period 311. The end of TXOP 311 is almost aligned to the DL start time so that the acknowledgment that follows (e.g., BACK 331 to be received by the WiFi radio module) does not overlap with uplink period 310.

In one embodiment, simultaneous transmission and reception of the co-located radios (e.g., WiFi radio module 120 and 4G radio module with respect to FIG. 1) are completely avoided.

FIG. 3B shows a waveform diagram for WiFi operations during an uplink-downlink transition in accordance with one embodiment of the invention. FIG. 3B further illustrates details during the transitioning time between 4G UL and DL. In one embodiment, referring to FIG. 3B, a 4G frame comprises a downlink portion (e.g., downlink period 362), an uplink portion (e.g., uplink period 360), and an uplink-downlink transition gap (RTG 361). A frame synchronization signal shows synchronization pulse 370. WiFi operations show transmission period 381, inter-frame space 382, and acknowledgement 383. In one embodiment, inter-frame space 382 is a short inter-frame space (SIFS). In one embodiment, acknowledgment 383 is a WiFi acknowledgement with respect to transmission period 381.

In one embodiment, WiFi radio operates in conjunction with a slotted random channel access, which is a random channel access procedure where the time domain is divided into time slots (e.g., a WiFi slot 381). In one embodiment, WiFi operation is logically divided into time slots (e.g., time slot 380)

In one embodiment, depending on the WiFi standard (802.11a/b/g/n), the size of a WiFi slot is, for example, either 9 us or 20 us. The slot is of a smaller granularity compared with the duration of 4G radio frame. The slot is also smaller than the transitioning guard periods (e.g., RTG 361).

In one embodiment, a co-located WiFi radio module controls its transmission to align substantially with an uplink period (e.g., UL 360). In one embodiment, a WiFi radio module controls its reception to align substantially with a downlink period (e.g., DL 362) so that the transmission does not affect operations of the co-located 4G radio.

In one embodiment, in view of a guard period (e.g., RTG 361) and inter-frame space 382 (between WiFi transmission 381 and acknowledgement 383), the WiFi radio is more flexible in the scheduling process such that WiFi transmission 381 does not overlap with a 4G DL period (e.g., DL 362) and WiFi reception (e.g., WiFi ACK 383) does not overlap with 4G UL period (e.g., UL 360).

It will be appreciated by those skilled in the art that these mechanism is also applicable to align reception operations with respect to downlink-uplink boundaries.

In one embodiment, a coexistence mode prevents simultaneous transmissions and receptions of co-located radios. The coexistence mode is performed without additional filtering or strict MAC coordination. In one embodiment, a coexistence system supports intensive usage scenario, such as, for example, transmitting data for wireless display.

In one embodiment, in a wireless display technology application, a co-located WiFi radio (as a part of MRP) primarily transmits video content to a remote WiFi adapter at TV side. The WiFi radio receives acknowledgement from the TV WiFi adapter. In one embodiment, WiFi channel utilization efficiency is defined by TXOP/T_{frame}. TXOP is bounded by the length of a 4G uplink period. For example, the duration of TXOP is 1.0-1.5 ms. In one embodiment, the typical throughput of WiFi operating at a 802.11n 2×2 mode is around 80 Mbps. A co-located WiFi radio is able to achieve 16-24 Mbps throughput if WiFi channel utilization is about 20%-30%. The throughput is sufficient to support the wireless display throughput requirement.

### Embodiments

In one embodiment, a radio module (e.g., WiFi radio module 120 with respect to FIG. 1) is operable to schedule transmission within a transmission opportunity period (TXOP) and to determine a reception opportunity period (RXOP). The frame synchronization signal is from another radio module (e.g., 4G radio module 110) co-located with the WiFi radio. The 4G radio module is operable to send data during an uplink period (UL) and to receive data during a downlink period (DL).

In one embodiment, a radio module determines/calculates a DL start time which is a part of estimated frame timing information. The WiFi radio module schedules the transmission based at least on the DL start time such that the transmission end time is aligned to before DL start time and a corresponding transmission acknowledgment is aligned to after the DL start time.

In one embodiment, a radio module determines a UL start time which is part of estimated frame timing information. The radio module determines a reception opportunity period based on the UL start time such that the reception opportunity end time is aligned to before the UL start time. An acknowledgment corresponding the reception opportunity period is aligned to after the UL start time. The radio module communicates the reception opportunity period to a remote entity for scheduling purposes.

In one embodiment, a radio module is operable to align a transmission period with the uplink period and to prevent the transmission period overlapping with a downlink period. The radio module is operable to align a reception period with the downlink period and to prevent the reception period overlapping with an uplink period.

In one embodiment, a radio module performs the transmission during a non-overlapping period between the transmission and a downlink period.

In one embodiment, a radio module performs the transmission during a part of the uplink period and performs reception during a part of the downlink period, such that simultaneous transmission and reception does not occur.

In one embodiment, a radio module performs receives frame parameters including non-realtime values, such as, for example, an offset, the duration of a frame period, and a downlink-uplink ratio. The radio module is operable to determine a DL start time based at least on the offset and a downlink frame synchronization signal. The radio module is able to determine a UL start time based at least on the downlink-uplink ratio and the downlink frame synchronization signal.

In one embodiment, a WiFi radio module (e.g., WiFi radio module 120 with respect to FIG. 1) determines whether to operate in a coexistence mode. The radio module determines whether the coexistence mode has been enabled. In one embodiment, the radio module includes frame pattern logic, channel access logic, and scheduling logic. The frame pattern logic derives frame pattern information including the start time of the downlink period based on a realtime synchronization signal and some non-realtime parameters. The channel access logic is operable to align transmission opportunity period (TXOP) to finish prior to a downlink period start time (if the TXOP is fixed). The scheduling logic is operable to increase non-overlapping time period between a transmission and the downlink period based at least on the frame pattern information. The scheduling logic is also operable to increase or to decrease the duration of a TXOP such that the end time of the TXOP is aligned with a downlink period start time.

In one embodiment, a 4G radio module (4G radio module 110 with respect to FIG. 1) is operable to determine whether a coexistence mode is enabled. If the coexistence mode is enabled, the 4G radio module generates a frame synchronization signal. The frame sync signal is for use by a proximate radio to derive the start time of a downlink period.

In one embodiment, in a basic coexistence mode, a co-located WiFi radio adjusts the channel access procedure to align the transmission and reception operations along the boundary between 4G UL and DL periods.

### Random Channel Access

In one embodiment, as a co-located WiFi radio is only available for part of the time (acting as a control point of a PAN network), the WiFi radio sends notification to one or more remote WiFi devices about the availability using “CTS-to-self” or “Notification of Absence” in accordance with IEEE 802.11v. WiFi channel access procedure may be performed in two ways to support the scheduling described herein.

### Fixed Duration of Transmission Opportunity Period

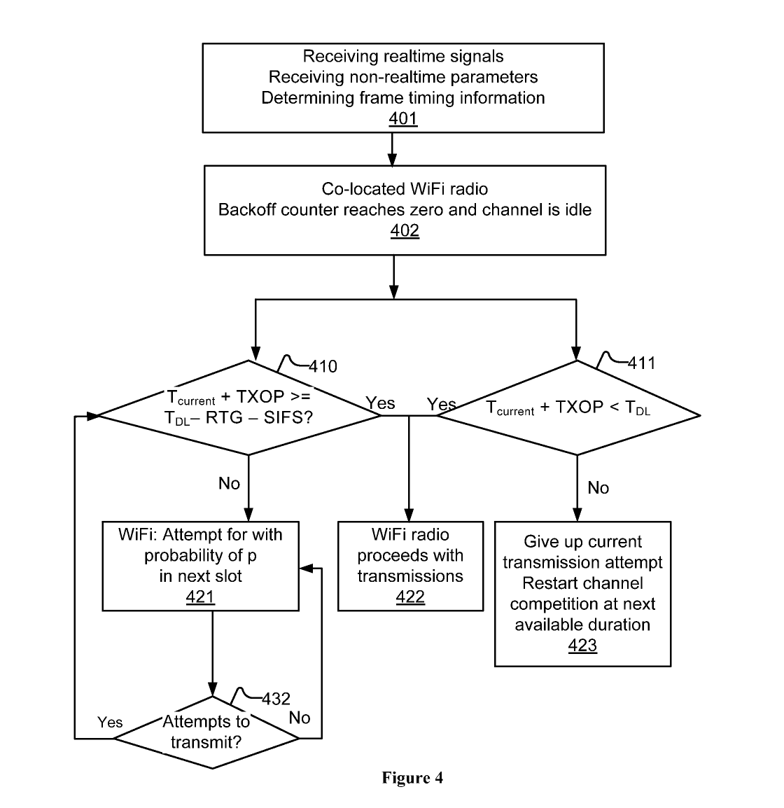

FIG. 4 is a flow diagram of one embodiment of a process if a transmission opportunity period is fixed. The process is performed by processing logic that may comprise hardware (circuitry, dedicated logic, etc.), software (such as one that is run on a general purpose computer system or a dedicated machine), or a combination of both. In one embodiment, the process is performed in conjunction with an apparatus with coexistence system architecture (e.g., a WiFi/4G coexistence system with respect to FIG. 1). In one embodiment, the process is performed by a mobile station, a UE, or the like.

Referring to FIG. 4, in one embodiment, processing logic begins by receiving one or more realtime signals including a frame synchronization signal (process block 401). Processing logic also receives non-realtime frame parameters. Processing logic is operable to estimate frame timing information (e.g., DL start time) based at least on the frame synchronization signal. Processing logic attempts to schedule transmission based on the estimated frame timing information to avoid collision of the transmission and reception.

In one embodiment, for example, a WiFi radio operates in conjunction with a fixed size transmission opportunity period (TXOP). Referring to FIG. 4, in one embodiment, a WiFi radio operates in accordance with a random access procedure to compete for channel access when the channel is available for transmission. When a backoff counter of the WiFi radio reaches zero and the channel is idle (process block 402), the WiFi radio performs in accordance with Table 1 not limited to any particular order. In one embodiment, a process of random channel access in conjunction with a fixed size TXOP is shown in Table 1.

TABLE 1
Random channel access with a fixed size TXOP
Notation:

T_{DL}: The beginning of a next immediate 4G DL duration
RTG: An uplink-downlink transition guard period
T_{current}: Current time
SIFS: short inter-frame space
TXOP: The duration of WiFi transmission opportunity (excluding
SIFS and ACK time)
1) A WiFi radio determines whether:
T_{DL} − RTG − SIFS ≦ T_{current} + TXOP < T_{DL}
(process block 410; process block 411)
If T_{DL} − RTG − SIFS ≦ T_{current} + TXOP < T_{DL}
A WiFi radio proceeds with transmission (process block 422)
2) A WiFi radio determines whether
T_{current} + TXOP < T_{DL} − RTG − SIFS (process block 410)
If so, a WiFi radio tries to access the channel in subsequently slots
(with probability p). (process block 421)
Before transmission, the WiFi radio returns to step 1 condition.
The probability p may be determined based on the anticipated
number of transmitters competing with the WiFi radio (in a typical
PAN network, the number is usually small).
3)) A WiFi radio determines whether
T_{current} + TXOP ≧ T_{DL} (process block 411)
If so, a WiFi radio gives up current transmission attempt and
repeats the channel competition procedure at next available
duration (e.g., during a next 4G frame), (process block 423)

In one embodiment, in conjunction with a channel access procedure, a WiFi radio attempts (with a probability p) to transmit in a subsequent slot if a TXOP end time (e.g., T_{current}+TXOP) is earlier than a DL start time deducted by a sum of an uplink-downlink transition guard period and an interference space period.

In one embodiment, a WiFi radio determines whether or not to transmit based at least on whether a TXOP end time is before a DL start time. In conjunction with a channel access procedure, a WiFi radio performs transmission if (at least) a sum of current time and a TXOP is less than a following DL start time. Otherwise, the WiFi radio performs channel competition at a next available period rather than transmitting at the current time.

### Variable Duration of Transmission Opportunity Period

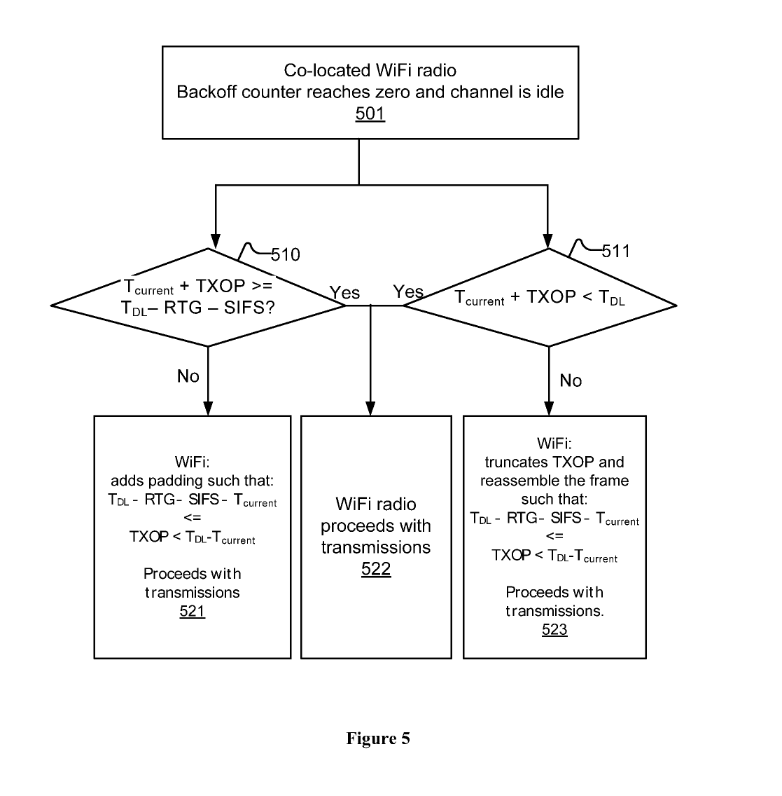

FIG. 5 is a flow diagram of one embodiment of a process if a transmission opportunity period is variable. The process is performed by processing logic that may comprise hardware (circuitry, dedicated logic, etc.), software (such as one that is run on a general purpose computer system or a dedicated machine), or a combination of both. In one embodiment, the process is performed in conjunction with an apparatus with coexistence system architecture (e.g., a WiFi/4G coexistence system with respect to FIG. 1). In one embodiment, the process is performed by a mobile station, a UE, or the like.

Referring to FIG. 5, in one embodiment, processing logic (e.g., a WiFi radio) operates in accordance with a standard random backoff procedure to complete channel access when the channel is available for transmission. In one embodiment, when a backoff counter of the WiFi radio reaches zero and the channel is idle, the WiFi radio performs in accordance with Table 2 but not limited to any particular order (process block 501).

TABLE 2
Random channel access with a variable size TXOP

1) A WiFi radio determines whether
T_{DL} − RTG − SIFS ≦ T_{current} + TXOP < T_{DL}
(process block 510; process block 511)
If T_{DL} − RTG − SIFS ≦ T_{current} + TXOP < T_{DL}
A WiFi radio proceeds with transmission (process block 522)
2) A WiFi radio determines whether
T_{current} + TXOP < T_{DL} − RTG − SIFS (process block 510)
If so, a WiFi radio adds padding to TXOP (increasing the duration
thereof) such that
T_{DL} − RTG − SIFS − T_{current} ≦ TXOP < T_{DL} − T_{current} and then
proceeds with transmission (process block 521)
3)) A WiFi radio determines whether
T_{current} + TXOP ≧ T_{DL} (process block 511)
If so, a WiFi radio truncates the size of TXOP (reducing the
duration thereof) and reassembles the frame such that
T_{DL} − RTG − SIFS − T_{current} ≦ TXOP < T_{DL} − T_{current}
The WiFi radio proceeds with transmission (process block 523)

In one embodiment, a WiFi radio tweaks (by adding or truncating) the duration of a TXOP such that the TXOP is within a first value and a second a value. The first value is the DL start time minus current time. The second value is the DL start time deducted by a sum of an uplink-downlink transition guard period, an inter-frame space period, and the current time.

Coexistence Mode with Bidirectional Communication

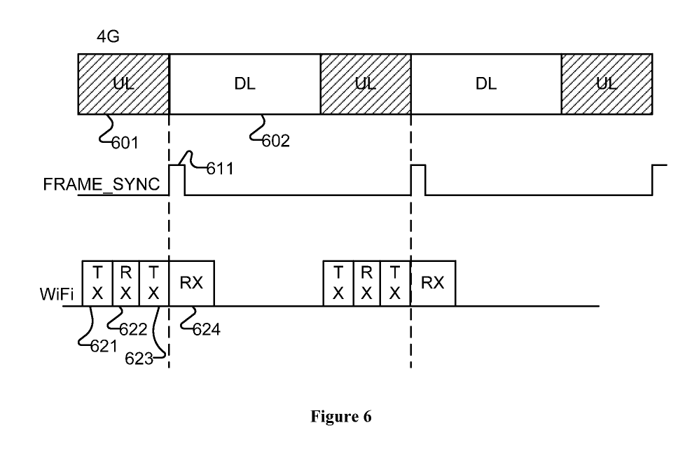

FIG. 6 shows a waveform diagram for bidirectional WiFi operations in accordance with one embodiment of the invention. In one embodiment, referring to FIG. 6, a 4G frame comprises a downlink portion (e.g., downlink period 602) and an uplink portion (e.g, uplink period 601). A frame synchronization signal shows synchronization pulse 611. WiFi operations show transmission opportunity period (TXOP 621), TXOP 623, reception opportunity period (RXOP 622), and RXOP 624. In one embodiment, acknowledgment of transmission is not shown (for example, the acknowledgment is received along with RXOP).

In one embodiment, in a coexistence mode with respect to FIG. 3B, WiFi operations prevent WiFi transmissions overlapping with 4G receptions and also prevent WiFi receptions overlapping with 4G transmissions. In another embodiment, in an enhanced coexistence mode with respect to FIG. 6, WiFi operations support WiFi receptions overlapping with 4G transmissions because of the fact that WiFi personal area network (PAN) typically has a reduced range among WiFi devices.

For example, a wireless device peak sensitivity level is −89 dBm at a modulation rate of 6 Mbps (in conjunction with BPSK ½). In a general PAN usage scenario, such as, for example, a wireless display application, the required sensitivity level is more relaxed. For example, a wireless device requires a transmission range of 12 feet with a sensitivity requirement at −68 dBm. With the sensitivity margin of 20 dB, a WiFi radio is able to tolerate some interference from a co-located 4G radio.

In one embodiment, a co-located WiFi radio (of a MRP) requests a remote WiFi device to transmit at a low modulation rate (e.g., 1 Mbps, 6 Mbps, and 11 Mbps). Based on IEEE 802.11, a receiver is able to notify a sender (e.g., an access point, the remote WiFi device) the rates which the receiver supports. A receiver includes only low modulation rates in such notification. The sender, in response to the notification, uses low modulate rates for transmissions. When the sender uses low modulation rates, the co-located WiFi radio is able to receive correctly even during a 4G UL period (e.g., UL 601). This allows bidirectional packet exchanges (e.g., TXOP 621, RXOP 622, and TXOP 623) between both the sender and the receiver during entire 4G UL. In one embodiment, both WiFi RTS/CTS (Request to Send/Clear to Send) channel access mode and Data/ACK access mode are supported. Multiple WiFi packet exchanges occur during 4G UL to support bidirectional communication.

In one embodiment, to determine whether to proceed with a WiFi transmission, a WiFi radio determines whether T_{current}+TXOP<T_{SL}. If the condition is satisfied, the WiFi radio proceeds with the transmission.

In one embodiment, a WiFi radio operates in accordance with a standard random backoff procedure to complete channel access when the channel is available for transmission. In one embodiment, when a backoff counter of the WiFi radio reaches zero and the channel is idle, the WiFi radio performs in accordance with Table 3.

TABLE 3
Random channel access with bidirectional communication

1) A WiFi radio determines whether:
T_{current} + TXOP < T_{DL}
If T_{current} + TXOP < T_{DL}, a WiFi radio proceeds with transmission
2) Otherwise, the WiFi radio gives up a current transmission
attempt and repeats the channel competition at a next available
period (during a next 4G frame period)

In one embodiment, a WiFi radio is operable to cause a remote entity to transmit at a reduced modulation rate. For example, the WiFi radio sends notification to the remote entity about the modulation rates supported by the WiFi radio. For example, the WiFi radio is operable to only acknowledge to data transmitted at the reduced modulation rate. The WiFi radio requests the remote entity to transmit at a reduced modulation rate to enable both transmission and reception in an alternate manner during a part of the uplink period (e.g., UL 601). In one embodiment, a WiFi radio performs bidirectional packet exchange during a part of the uplink period.

In one embodiment, in an enhanced coexistence mode, a co-located WiFi radio requests a remote WiFi device to transmit at a low modulation rate such that both transmissions/receptions of the co-located WiFi radio are possible during 4G UL.

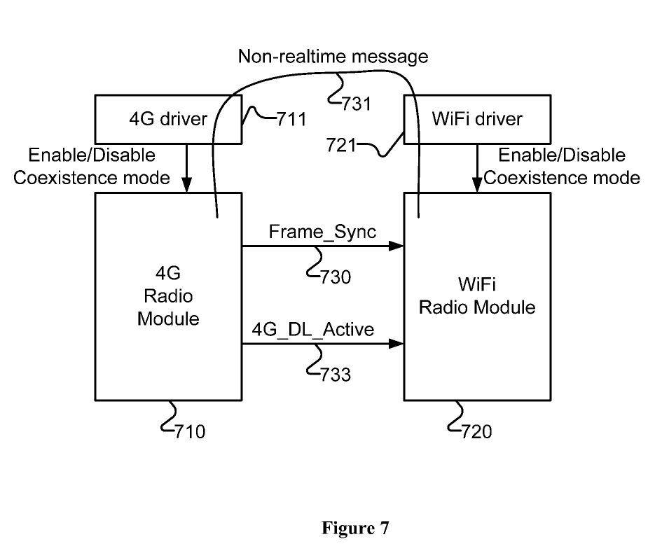

FIG. 7 is a block diagram of WiFi/4G system architecture with a downlink active signal, in accordance with one embodiment of the invention. Many related components such as buses and peripherals have not been shown to avoid obscuring the invention. Referring to FIG. 7, the system comprises 4G radio module 710, 4G driver 711, WiFi radio module 720, and WiFi driver 721. In one embodiment, 4G radio module 710 sends frame synchronization signal 730 to WiFi radio module 720. 4G radio module 710 sends non-realtime messages 731 which contain frame parameters to WiFi radio module 720. In one embodiment, 4G radio module 710 sends 4G downlink active signal 733 to WiFi radio module 720.

In one embodiment, the aforementioned units are shown as discrete components. Other embodiments are possible where some or all of units of a same RAT are integrated within a device or within other components. In other embodiments, the aforementioned units are distributed throughout a system in hardware, software, or some combination thereof.

In one embodiment, referring to FIG. 7, components/modules perform and operate substantially similar to corresponding components/modules with respect to FIG. 1.

In one embodiment, WiFi transmission is prevented during a 4G downlink period. For a WiFi radio to opportunistically use the time when 4G radio module 710 is not actively receiving (within a 4G downlink period), 4G radio module 710 generates 4G downlink active signal 733 (4G_DL_Active). 4G radio module 710 sends the signal to WiFi radio module 720.

In one embodiment, if 4G downlink active signal 733 is asserted, the signal is indicative of that 4G radio module 710 is actively receiving data. Therefore, WiFi radio module 720 prevents starting a new transmission and stalls/stops a transmission if the transmission has already started. In one embodiment, 4G downlink active signal 733 is used in conjunction with a frame synchronization signal (e.g., frame synchronization signal 730), non-realtime messages, or both.

In one embodiment, WiFi radio module 720 receives a downlink active signal. The WiFi radio is operable to prevent scheduling a transmission to occur at time when the downlink active signal is asserted. In one embodiment, 4G radio module 710 generates a downlink active signal to be sent to a proximate radio (e.g., WiFi radio 720). The downlink active signal is indicative of active receiving duration of 4G radio.

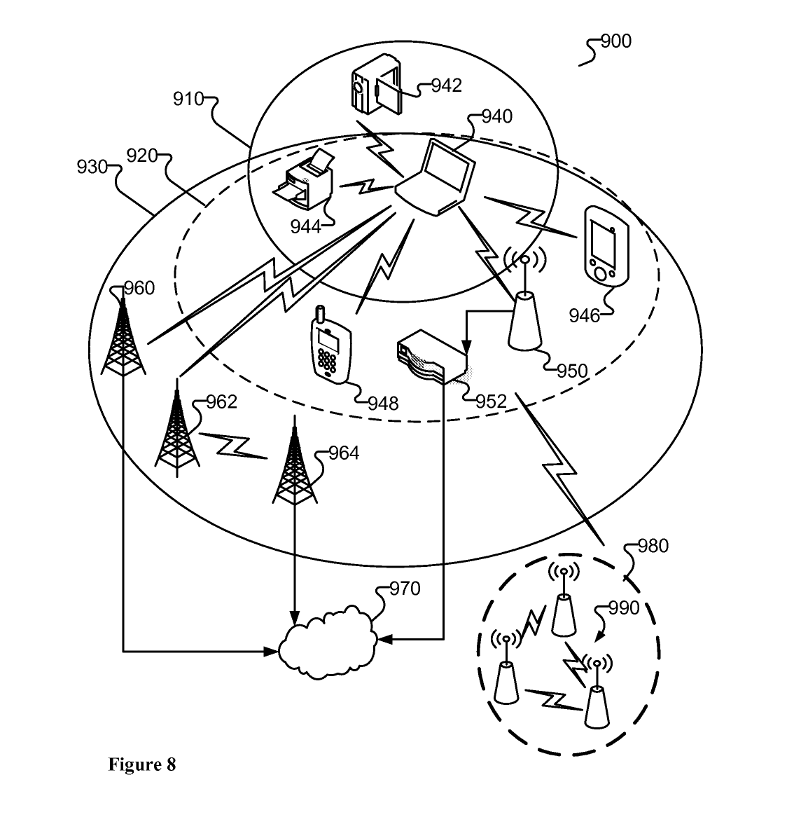

FIG. 8 is a diagram representation of a wireless communication system in accordance with one embodiment of the invention. Referring to FIG. 8, in one embodiment, wireless communication system 900 includes one or more wireless communication networks, generally shown as 910, 920, and 930.

In one embodiment, the wireless communication system 900 includes a wireless personal area network (WPAN) 910, a wireless local area network (WLAN) 920, and a wireless metropolitan area network (WMAN) 930. In other embodiments, wireless communication system 900 includes additional or fewer wireless communication networks. For example, wireless communication network 900 includes additional WPANs, WLANs, and/or WMANs. The methods and apparatus described herein are not limited in this regard.

In one embodiment, wireless communication system 900 includes one or more subscriber stations (e.g., shown as 940, 942, 944, 946, and 948). For example, the subscriber stations 940, 942, 944, 946, and 948 include wireless electronic devices such as, for example, a desktop computer, a laptop computer, a handheld computer, a tablet computer, a cellular telephone, a pager, an audio/video player (e.g., an MP3 player or a DVD player), a gaming device, a video camera, a digital camera, a navigation device (e.g., a GPS device), a wireless peripheral (e.g., a printer, a scanner, a headset, a keyboard, a mouse, etc.), a medical device (e.g., a heart rate monitor, a blood pressure monitor, etc.), and other suitable fixed, portable, or mobile electronic devices. In one embodiment, wireless communication system 900 includes more or fewer subscriber stations.

In one embodiment, subscriber stations 940, 942, 944, 946, and 948 use a variety of modulation techniques such as spread spectrum modulation (e.g., direct sequence code division multiple access (DS-CDMA), frequency hopping code division multiple access (FH-CDMA), or both), time-division multiplexing (TDM) modulation, frequency-division multiplexing (FDM) modulation, orthogonal frequency-division multiplexing (OFDM) modulation, multi-carrier modulation (MCM), other suitable modulation techniques, or combinations thereof to communicate via wireless links.

In one embodiment, laptop computer 940 operates in accordance with suitable wireless communication protocols that require very low power, such as, for example, Bluetooth®, ultra-wide band (UWB), radio frequency identification (RFID), or combinations thereof to implement the WPAN 910. In one embodiment, laptop computer 940 communicates with devices associated with the WPAN 910, such as, for example, video camera 942, printer 944, or both via wireless links.

In one embodiment, laptop computer 940 uses direct sequence spread spectrum (DSSS) modulation, frequency hopping spread spectrum (FHSS) modulation, or both to implement the WLAN 920 (e.g., a basic service set (BSS) network in accordance with the 802.11 family of standards developed by the Institute of Electrical and Electronic Engineers (IEEE) or variations and evolutions of these standards). For example, laptop computer 940 communicates with devices associated with the WLAN 920 such as printer 944, handheld computer 946, smart phone 948, or combinations thereof via wireless links.

In one embodiment, laptop computer 940 also communicates with access point (AP) 950 via a wireless link. AP 950 is operatively coupled to router 952 as described in further detail below. Alternatively, AP 950 and router 952 may be integrated into a single device (e.g., a wireless router).

In one embodiment, laptop computer 940 uses OFDM modulation to transmit large amounts of digital data by splitting a radio frequency signal into multiple small sub-signals, which in turn, are transmitted simultaneously at different frequencies. In one embodiment, laptop computer 940 uses OFDM modulation to implement WMAN 930. For example, laptop computer 940 operates in accordance with the 802.16 family of standards developed by IEEE to provide for fixed, portable, mobile broadband wireless access (BWA) networks (e.g., the IEEE std. 802.16, published 2004), or combinations thereof to communicate with base stations, shown as 960, 962, and 964, via wireless link(s). For example, laptop computer 940 operates in accordance with LTE, advanced LTE, 3GPP2, 4G or related versions thereof.

Although some of the above examples are described above with respect to standards developed by IEEE, the methods and apparatus disclosed herein are readily applicable to many specifications, standards developed by other special interest groups, standard development organizations (e.g., Wireless Fidelity (Wi-Fi) Alliance, Worldwide Interoperability for Microwave Access (WiMAX) Forum, Infrared Data Association (IrDA), Third Generation Partnership Project (3GPP), etc.), or combinations thereof. The methods and apparatus described herein are not limited in this regard.

WLAN 920 and WMAN 930 are operatively coupled to network 970 (public or private), such as, for example, the Internet, a telephone network (e.g., public switched telephone network (PSTN)), a local area network (LAN), a cable network, and another wireless network via connection to an Ethernet, a digital subscriber line (DSL), a telephone line, a coaxial cable, any wireless connection, etc., or combinations thereof.

In one embodiment, WLAN 920 is operatively coupled to network 970 via AP 950 and router 952. In another embodiment, WMAN 930 is operatively coupled to network 970 via base station(s) 960, 962, 964, or combinations thereof. Network 970 includes one or more network servers (not shown).

In one embodiment, wireless communication system 900 includes other suitable wireless communication networks, such as, for example, wireless mesh networks, shown as 980. In one embodiment, AP 950, base stations 960, 962, and 964 are associated with one or more wireless mesh networks. In one embodiment, AP 950 communicates with or operates as one of mesh points (MPs) 990 of wireless mesh network 980. In one embodiment, AP 950 receives and transmits data in connection with one or more of MPs 990. In one embodiment, MPs 990 include access points, redistribution points, end points, other suitable connection points, or combinations thereof for traffic flows via mesh paths. MPs 990 use any modulation techniques, wireless communication protocols, wired interfaces, or combinations thereof described above to communicate.

In one embodiment, wireless communication system 900 includes a wireless wide area network (WWAN) such as a cellular radio network (not shown). Laptop computer 940 operates in accordance with other wireless communication protocols to support a WWAN. In one embodiment, these wireless communication protocols are based on analog, digital, or dual-mode communication system technologies, such as, for example, Global System for Mobile Communications (GSM) technology, Wideband Code Division Multiple Access (WCDMA) technology, General Packet Radio Services (GPRS) technology, Enhanced Data GSM Environment (EDGE) technology, Universal Mobile Telecommunications System (UMTS) technology, High-Speed Downlink Packet Access (HSDPA) technology, High-Speed Uplink Packet Access (HSUPA) technology, other suitable generation of wireless access technologies (e.g., 3G, 4G, etc.) standards based on these technologies, variations and evolutions of these standards, and other suitable wireless communication standards. Although FIG. 8 depicts a WPAN, a WLAN, and a WMAN, In one embodiment, wireless communication system 900 includes other combinations of WPANs, WLANs, WMANs, and WWANs. The methods and apparatus described herein are not limited in this regard.

In one embodiment, wireless communication system 900 includes other WPAN, WLAN, WMAN, or WWAN devices (not shown) such as, for example, network interface devices and peripherals (e.g., network interface cards (NICs)), access points (APs), redistribution points, end points, gateways, bridges, hubs, etc. to implement a cellular telephone system, a satellite system, a personal communication system (PCS), a two-way radio system, a one-way pager system, a two-way pager system, a personal computer (PC) system, a personal data assistant (PDA) system, a personal computing accessory (PCA) system, other suitable communication system, or combinations thereof.

In one embodiment, subscriber stations (e.g., 940, 942, 944, 946, and 948) AP 950, or base stations (e.g., 960, 962, and 964) includes a serial interface, a parallel interface, a small computer system interface (SCSI), an Ethernet interface, a universal serial bus (USB) interface, a high performance serial bus interface (e.g., IEEE 1394 interface), any other suitable type of wired interface, or combinations thereof to communicate via wired links. Although certain examples have been described above, the scope of coverage of this disclosure is not limited thereto.

Embodiments of the invention may be implemented in a variety of electronic devices and logic circuits. Furthermore, devices or circuits that include embodiments of the invention may be included within a variety of computer systems. Embodiments of the invention may also be included in other computer system topologies and architectures.

The invention is not limited to the embodiments described, but can be practiced with modification and alteration within the spirit and scope of the appended claims. For example, it should be appreciated that the present invention is applicable for use with all types of semiconductor integrated circuit (“IC”) chips. Examples of these IC chips include but are not limited to processors, controllers, chipset components, programmable logic arrays (PLA), memory chips, network chips, or the like. Moreover, it should be appreciated that exemplary sizes/models/values/ranges may have been given, although embodiments of the present invention are not limited to the same. As manufacturing techniques (e.g., photolithography) mature over time, it is expected that devices of smaller size could be manufactured.

Whereas many alterations and modifications of the embodiment of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite only those features regarded as essential to the invention.

What is claimed is:

1. A method for radio access technology comprising:
receiving one or more realtime signals including a frame synchronization signal;
receiving one or more frame parameters;
determining, based at least on the frame synchronization signal and the frame parameters, estimated frame timing information;
scheduling transmission based on the estimated frame timing information to avoid collision of the transmission and reception.

2. The method of claim 1, wherein the scheduling is by a first radio operable to schedule transmission within a transmission opportunity period (TXOP) and to determine a reception opportunity period, wherein the frame synchronization signal is from a second radio, co-located with the first radio, operable to send data during an uplink period (UL) and to receive data during a downlink period (DL), wherein the second radio communicate wirelessly over multiple sub-channels in an orthogonal frequency division multiplexing (OFDM) network.

3. The method of claim 1, further comprising:
determining a DL start time which is a part of the estimated frame timing information; and
scheduling the transmission based at least on the DL start time such that the transmission end time is aligned to before DL start time, and a corresponding transmission acknowledgment is aligned to after the DL start time.

4. The method of claim 1, further comprising:
determining a UL start time which is part of the estimated frame timing information;
determining a reception opportunity period based on the UL start time such that the reception opportunity end time is aligned to before the UL start time, whereas, an acknowledgment corresponding the reception opportunity period is aligned to after the UL start time; and
communicating the reception opportunity period to a remote entity as scheduling information.

5. The method of claim 1, further comprising scheduling a TXOP to finish before the downlink period and an acknowledgement corresponding to the TXOP to begin after a UL start time.

6. The method of claim 1, further comprising:
aligning a transmission period to the uplink period to prevent the transmission period overlapping with a downlink period; and
aligning a reception period to the downlink period to prevent the reception period overlapping with an uplink period.

7. The method of claim 1, further comprising performing the transmission during a non-overlapping period between the transmission and a downlink period.

8. The method of claim 2, further comprising:
performing the transmission during a part of the uplink period; and
performing reception during a part of the downlink period, without simultaneous transmission and reception by the first radio, wherein the first radio is a part of a multi-radio platform.

9. The method of claim 1, further comprising determining whether to transmit or not based on whether a TXOP end time is before a DL start time, wherein duration of the TXOP is fixed.

10. The method of claim 1, further comprising tweaking duration of a TXOP, if the duration of the TXOP is variable, such that the TXOP is within a first value and a second a value, the first value being the DL start time minus current time, the second value being the DL start time deducted by a sum of an uplink-downlink transition guard period, an inter-frame space period, and the current time.

11. The method of claim 1, further comprising in conjunction with a channel access procedure, transmitting if a sum of current time and a TXOP is less than a following DL start time, otherwise, performing channel competition at a next available period rather than transmitting at the current time.

12. The method of claim 1, further comprising in conjunction with a channel access procedure, attempting, with a probability, to transmit in a subsequent slot if duration of a TXOP is fixed and if a TXOP end time is less than a DL start time deducted by a sum of an uplink-downlink transition guard period and an interference space period.

13. The method of claim 1, further comprising adjusting a TXOP to a shorter period or a longer period if it is a varying TXOP.

14. The method of claim 2, further comprising causing a remote entity, communicatively linked to the first radio, to transmit at a reduced modulation rate, wherein the first radio is operable to only acknowledge to data transmitted at the reduced modulation rate.

15. The method of claim 2, further comprising requesting a remote entity which communicates with the first radio, to transmit at a reduced modulation rate to enable both transmission and reception in an alternate manner by the first radio during a part of the uplink period.

16. The method of claim 15, further comprising performing bidirectional packet exchange during a part of the uplink period.

17. The method of claim 2, further comprising:
receiving a downlink active signal; and
preventing scheduling a transmission to occur at time when the downlink active signal is asserted.

18. The method of claim 1, wherein the frame parameters are non-realtime values including an offset, duration of a frame period, and a downlink-uplink ratio, the method further comprising:
determining a DL start time based at least on the offset and a downlink frame synchronization signal; and
determining an UL start time based at least on the downlink-uplink ratio and the downlink frame synchronization signal.

19. An apparatus supporting a first radio communicatively linked to a second radio which communicates during an uplink period and a downlink period, the first radio comprising:
frame pattern logic operable to derive frame pattern information including at least start time of the downlink period, based at least in part on a realtime synchronization signal and non-realtime parameters; and
scheduling logic operable to increase non-overlapping time between a transmission and the downlink period based at least on the frame pattern information.

20. The apparatus of claim 19, further comprising channel access logic operable to align transmission opportunity period (TXOP) to finish prior to a downlink period start time, if the TXOP is fixed.

21. The apparatus of claim 19, wherein the scheduling logic is operable to increase or to decrease TXOP such that the end time of the TXOP is aligned with a downlink period start time.

22. A multi-radio wireless communication system comprising:
a WiFi radio module; and
a 4G radio module, wherein the 4G radio module includes a coexist controller that is operable to assert a frame synchronization signal, wherein the WiFi radio module is operable to estimate a downlink period start time based at least on the frame synchronization signal and is operable to determine time to perform a transmission so that the transmission ends before the downlink period start time.

23. The multi-radio wireless communication of claim 22, wherein the WiFi radio module includes channel access logic operable to determine whether to perform transmission based at least on the downlink period start time, an offset value, current time, and duration of a transmission opportunity period.

24. A method for radio access technology comprising:
determining whether a coexistence mode is enabled;
generating a frame sync signal if the coexistence mode is enable, wherein the frame sync signal is for use by a proximate second radio to derive a start time of a downlink period; and
receiving data from a base station during the downlink period.

25. The method of claim 24, further comprising generating a downlink active signal to be sent to the proximate second radio, wherein the downlink active signal is indicative of active receiving duration of 4G radio.
